(19) United States
(12) Patent Application Publication
(10) Pub. No.: US 2020/0174514 A1
(43) Pub. Date: Jun. 4, 2020

(54) OPTICAL SIGNAL SKEW COMPENSATION

(71) Applicant: Intel Corporation, Santa Clara, CA (US)

(72) Inventors: Siamak Amiralizadeh Asl, San Jose, CA (US); Syed S. Islam, Cupertino, CA (US); Wenhua Lin, Fremont, CA (US)

(21) Appl. No.: 16/780,703

(22) Filed: Feb. 3, 2020

(51) Int. Cl. G06F 1/10; H04B 10/50; H04B 10/58; G02F 1/025; H04B 10/54

(52) U.S. Cl. CPC G06F 1/105; H04B 10/504; H04B 10/541; G02F 1/025; H04B 10/58

(57) ABSTRACT

Methods, apparatuses, and systems are described herein to compensate for a skew effect that occurs in an optical signal generated in response to an electrical to optical (E/O) conversion of an electrical signal carrying data received from a driver. A skew control device coupled with a driver or a modulator provides a skew to the electric signal prior to E/O conversion to compensate for the skew effect. The skew may be provided by a reverse-biased p-n junction diode. Other embodiments may be described and/or claimed.

### FIELD

Embodiments of the present disclosure generally relate to the field of optical transmission, in particular with respect to electro-optical conversion.

### BACKGROUND

Pulse amplitude modulation 4-level (PAM4) signaling is widely adopted in the current optical transceivers, where it enables 100 Gb/s per lane net data transmission rates. In contrast to non-return to zero (NRZ) implementations, PAM4 modulation doubles the data rate by encoding two bits into each symbol, resulting in a 4-level time-domain signal.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 is an example block diagram of an optical transmitter with eye skew compensation, in accordance with some embodiments.

FIG. 2 illustrates example capacitance vs. voltage characteristics of a p-n junction diode, in accordance with some embodiments.

FIG. 3 illustrates an example embodiment of a simplified circuit with a reverse-biased p-n junction diode, in accordance with some embodiments.

FIG. 4 illustrates an example response of a p-n junction diode to a sinusoidal input signal, in accordance with some embodiments.

FIGS. 5A-5E illustrate example results of simulations for transmitters with skew compensation, in accordance with some embodiments.

FIG. 6 illustrates a diagram of an example transmitter output with and without eye skew compensation, in accordance with some embodiments.

FIG. 7 is a block diagram that illustrates a method for implementing optical signal skew compensation, in accordance with some embodiments.

FIG. 8 is a schematic diagram of a computer system, in accordance with some embodiments.

### DETAILED DESCRIPTION

Methods, apparatuses, and systems are described herein to compensate for a skew effect that occurs in an optical signal generated in response to an electrical to optical (E/O) conversion of an electrical signal carrying data received from a driver in an optical device, such as a transmitter or transceiver. A skew control device coupled with a driver or a modulator provides a pre-skew to the electric signal prior to E/O conversion to compensate for the skew effect. The skew may be provided by a reverse-biased p-n junction diode.

Legacy PAM4 signaling is widely adopted in the current optical transceivers, and enables up to 100 Gb/s per lane net data transmission rates. In contrast to legacy NRZ implementations, PAM4 modulation doubles the data rate by encoding two bits into each symbol, resulting in a 4-level time-domain signal. Consequently, this 4-level signal is more vulnerable to noise, linear, and nonlinear distortions. Furthermore, the need to support higher capacity interconnections by using higher order PAM modulation (PAM4, PAM8, or PAM16) and data rates beyond 100 Gb/s per lane could increase signal vulnerability to noise, linear, and nonlinear distortions. The linear distortions can be mitigated through a linear equalizer, e.g., feed-forward equalizer (FFE), at the transmitter and the receiver. The nonlinear distortions are dealt with by optimizing the operation condition and/or accepting some link performance penalty in general since nonlinear distortions may require more complex compensation schemes.

In legacy implementations, one of the most common nonlinear effects in PAM4 systems is the asymmetric eye skew where the three individual eyes are misaligned. Depending on the technology, the skew can be due to various physical effects and components. The level-dependent eye skew occurs due to E/O conversion with a micro-ring modulator (MRM) or a directly modulated laser (DML).

In DMLs, the electrical signals are directly applied to the integrated gain section inside the laser cavity. The direct modulation mechanism of DML leads to simultaneous modulation of optical intensity and frequency, which may be known as chirp. As a result, different levels of a PAM signal experience different delays during transmission, which leads to eye skew. The direct modulation scheme in DMLs may bring significant benefits such as low cost, low power consumption, and small footprint; however, the induced nonlinear distortions limit their application in high-speed commercial products.

In silicon photonic MRMs (SiPh MRM), the modulation is achieved through plasma dispersion effect induced by free carrier absorption. For high-speed applications, the carrier depletion region is typically modulated by applying an electrical signal in a reverse-biased p-n junction. The resulting optical refractive index change leads to a phase change in the optical field, which can be translated into intensity modulation through a resonator structure. The phase change vs. voltage is nonlinear due to nonlinear behavior of the complex refractive index of the silicon with applied voltage. In addition, another contributing factor to SiPh MRM nonlinearity is the resonator structure, which leads to nonlinear loss in spectral response and memory effects. Combination of these effects results in level-dependent amplitude compression and eye skew as a characteristic of SiPh MRM-based transmitters.

The level-dependent skew in particular can be explained by the resonator structure of the ring modulator where the output signal is a combination of the current sample and previous samples after round-trips. Considering the round-trip time is much smaller than the symbol period, rising edge and falling edge of the PAM signals experience different contributions from previous samples leading to a skewed eye.

A majority of legacy commercial digital signal processors (DSPs) are able to compensate for the amplitude compression with a very small power consumption penalty at the transmitter. However, there is a lack of nonlinear skew compensation capability in the commercially available DSPs due to significant implementation complexity and power consumption. The modulation-induced nonlinear skew degrades the eye quality if no mitigation scheme is used. The resulting penalty depends on modulation technology (DML or MRM), PAM level, baud rate, bit error ratio (BER) requirements, and transmission reach.

From link performance point of view, the skew leads to transmitter and dispersion eye closure quaternary (TDECQ) penalty, a transmitter performance compliance. Considering that current PAM DSPs are based on a single sampling point at the receiver, the skew will also translate into significant BER penalty causing higher BER floor. Note that the skew effect generally gets worse after transmission over fiber due to dispersion.

In legacy implementations, there have been a few solutions directed to eye skew, and in general nonlinear distortions in optical communications. One solution is based on nonlinear FFE where the linear FFE concept is extended to enable equalization of nonlinear impairments. Another solution proposed in the literature is based on Volterra series equalizer, which is a well-known method for characterizing nonlinearity. Finally, some solutions have been proposed that rely on machine learning algorithms.

These legacy implementations have the disadvantage of being computationally expensive to implement and lead to considerable power consumption/cost increase. Most of these solutions require development of a custom DSP and are not compatible with existing clock and data recovery (CDRs). In addition, previous solutions set the equalization parameters to a factory setting, which can potentially lead to performance degradation over life, or the equalization parameters may attempt to adapt through power-hungry dummy receiver lanes.

Embodiments described herein are based on fundamental p-n junction diode characteristics resulting in voltage amplitude-dependent delay. In embodiments, the electrical PAM eye is skewed in the opposite direction (pre-skewed or pre-biased) with respect to the modulation block skew so that the optical eye at the transmitter output is uniformly aligned, therefore eliminating the impact of modulation nonlinear characteristics. The solution can be implemented in various configurations including integration of built-in p-n junction diode to the driver integrated circuit (IC), and/or integration of the p-n junction diode with a skew option in photonics in a hybrid or monolithic scheme.

Implementations of these embodiments may have several advantages. For example, they can be implemented in analog domain as part of the driver IC or in optical domain as part of the modulator photonic IC with very small additional complexity/power consumption, resulting in cost/energy-saving. In addition, these solutions compensate for the non-linear distortion by generating an opposite capacitance vs. voltage characteristics of the modulation based on similar physics and p-n junction characteristics. Therefore, these embodiments may be less sensitive to process, voltage, and temperature variations, which have an advantage of increased manufacturability. Also, these embodiments are compatible with different CDR types such as analog, digital, least significant bit (LSB)/most significant bit (MSB), and the like.

In the following description, various aspects of the illustrative implementations are described using terms commonly employed by those skilled in the art to convey the substance of their work to others skilled in the art. However, it will be apparent to one skilled in the art that embodiments of the present disclosure may be practiced without the specific details. In other instances, well-known features are omitted or simplified in order not to obscure the illustrative implementations.

In the following description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “including,” “having,” and the like, as used with respect to embodiments of the present disclosure, are synonymous.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

As used herein, the term “module” or “IC” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Various operations are described as multiple discrete operations in turn, in a manner that is most helpful in understanding the claimed subject matter. However, the order of description should not be construed as to imply that these operations are necessarily order dependent.

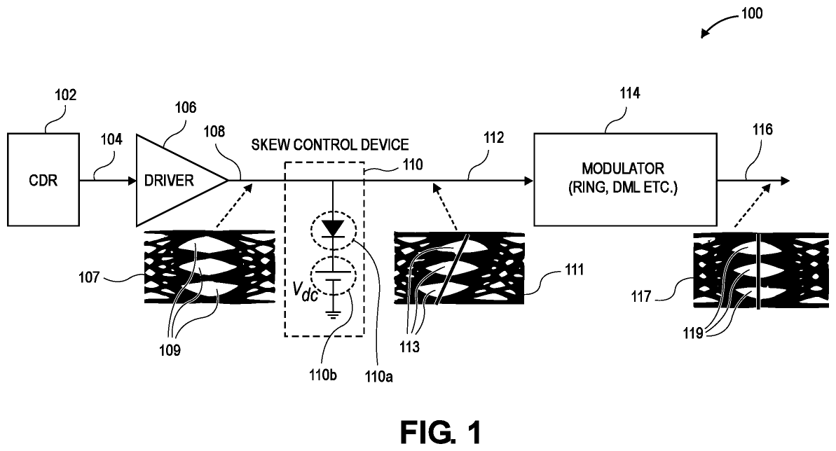

FIG. 1 is an example block diagram of an optical transmitter with eye skew compensation, in accordance with some embodiments. Diagram 100 shows components of an optical transmitter. A CDR 102, or some other appropriate device, generates a PAM-based electric signal 104 that carries data from the client/host side. The signal 104 is then amplified by a driver 106. The amplified signal 108, when analyzed, may show an un-skewed eye pattern 107 that includes three eyes 109 that are substantially vertically aligned (as shown for a PAM4 signal).

The amplified signal 108 is then sent to a skew control device 110, described further below, to provide a skew, which may also be referred to as pre-skew or skew correction. The skew control device 110 may be a component that is part of the transmitter. The pre-skewed signal 112 may show a skewed eye pattern 111, where the three eyes 113 are skewed and aligned in a substantially diagonal pattern. This pre-skewing compensates for the skew effect that is introduced after modulation.

The pre-skewed signal 112 is then sent to a modulator 114 that applies an E/O conversion, producing an optical signal 116 to an optical receiver in a switch or another computing device. The optical signal 116, when analyzed, shows a pattern 117 with minimal skew that includes three eyes 119 that are substantially vertically aligned. In this way, the pre-skewed signal 112 compensates for, or corrects for, skew in reverse direction that is introduced by the modulator 114. In embodiments, the modulator 114 may be a DML or a silicon photonic ring modulator.

The skew control device 110 achieves a compensating pre-skewed signal 112 by using a reverse biased p-n junction diode, which may include a diode 110a that is coupled with a skew 110b. The skew control device 110 can be implemented in the driver 106 integrated circuit (IC) or the photonic IC within modulator 114. In embodiments, any bandwidth degradation from the p-n junction capacitance may be eliminated through optimization of the driver 106 or through channel inductance, where inductive peaking may be introduced by the electrical channel connecting the driver 106 to the modulator 114.

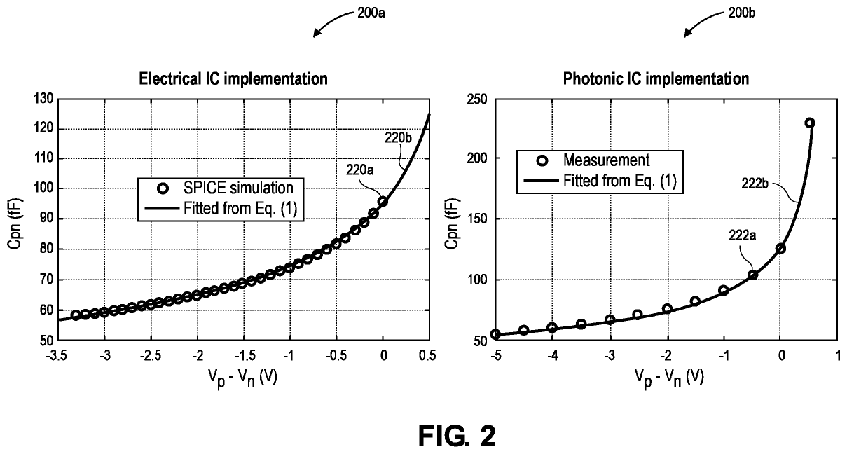

FIGS. 2-4 illustrate analysis and simulations to describe and clarify various embodiments. These figures include a simplified circuit with a sine wave input presented along with a theoretical analysis of skew due to the voltage-dependent capacitance of the p-n junction diode. Next, a transmitter electrical chain is simulated to show how the skew of the PAM4 signal can be controlled through the skew control device 110. Finally, 53 Gbaud PAM4 electro-optic co-simulation results are shown to quantify examples of the performance improvement from skew compensation. Note that while this description focuses on 100 Gb/s data rate with PAM4 modulations, the similar concept can be used for higher data rates and PAM modulation formats.

FIG. 2 illustrates example capacitance vs. voltage characteristics of a p-n junction diode to be used in an optical transmitter, in accordance with some embodiments. Diagram 200a shows the junction capacitance of a p-n junction diode versus the applied voltage for an electrical IC implementation of the skew control device. Diagram 200b shows the junction capacitance of a p-n junction diode versus the applied voltage for a photonic IC implementation of the skew control device. The junction capacitance of a reverse-biased p-n junction diode, Cₚₙ, is inversely proportional to the applied voltage and can be described as

$${C}_{pn} = \frac{{C}_{0}}{{( 1 - {V}_{pn} / {V}_{bi} )}^{γ}} \qquad ( 1 )$$

where V_{bi} is the diode built-in potential, Vₚₙ is the applied voltage across the junction, C₀ is the capacitance of unbiased diode, and γ is the material-dependent constant.

In diagram 200a markers 220a show the capacitance of a p-n junction diode typically used for electrostatic discharge (ESD) circuits in a deep-submicron radiofrequency (RF) complementary metal-oxide-semiconductor (CMOC) process obtained by Simulation Program with Integrated Circuit Emphasis (SPICE) simulations. In diagram 200b, markers 222a show measured capacitance versus voltage for a 100 μm-length waveguide doped with p-type and n-type material to form a p-n junction. The curves 220b and 222b show the fitted capacitance versus voltage using Eq. (1) above.

Note that the capacitance and resistance of the p-n junction depend strongly on the waveguide doping profile, and can be optimized depending on the skew needed. The measured resistance for the doped waveguide in this case may be very small and may have no impact on the skew compensation. For the analysis and the simulations presented below, the capacitance vs. voltage characteristics of the electrical IC implementation are assumed. The same conclusions apply for the photonic IC implementation.

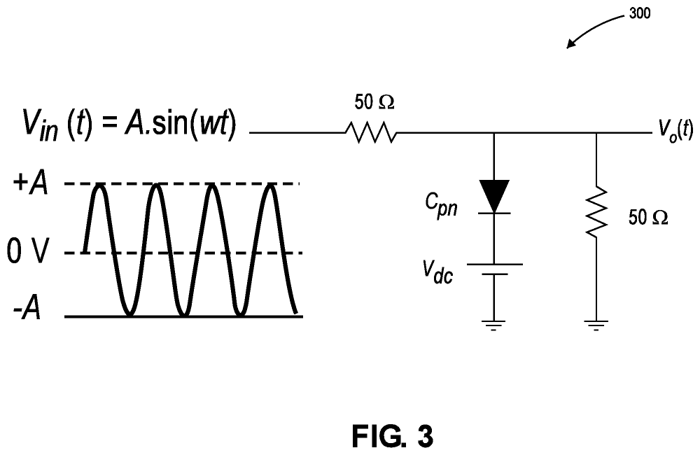

FIG. 3 illustrates an example embodiment of a simplified circuit with a reverse-biased p-n junction diode to be used for optical signal skew compensation, in accordance with some embodiments. Diagram 300 is a simplified circuit with a reverse-biased p-n junction diode and 50-ohm source/load resistance used to clarify behavior of the amplitude-dependent delay of embodiments described herein. Assuming a sinusoidal waveform as the input signal and using Eq. (1), the output signal, Vₒ(t), can be written as:

$${V}_{o} ( t ) = \frac{A}{2} \cdot sin ( w , t ) + 25 {Av}_{bi}^{γ} {C}_{0} [ \frac{\begin{matrix}w \cdot cos ( wt ) [ A ( γ - 1 ) \cdot sin ( wt ) + \\ {v}_{bi} + {v}_{dc} - γ {v}_{dc} ]\end{matrix}}{\begin{matrix}{( - A \cdot sin ( wt ) + {v}_{bi} + {v}_{dC} )}^{γ} \cdot \\ ( A \cdot sin ( wt ) - {v}_{bi} - {v}_{dC} )\end{matrix}} ] , \qquad ( 2 )$$

where A and w are the input sine wave amplitude and frequency, respectively. The first term in Eq. (2) is the input signal divided by two as a result of 50 ohm source and load impedance. The second term is the contribution from the voltage-dependent capacitance due to reverse-biased p-n junction, which leads to the intended skew effect. Note that V_{dc} is used to adjust the p-n junction diode operation point in reverse bias condition.

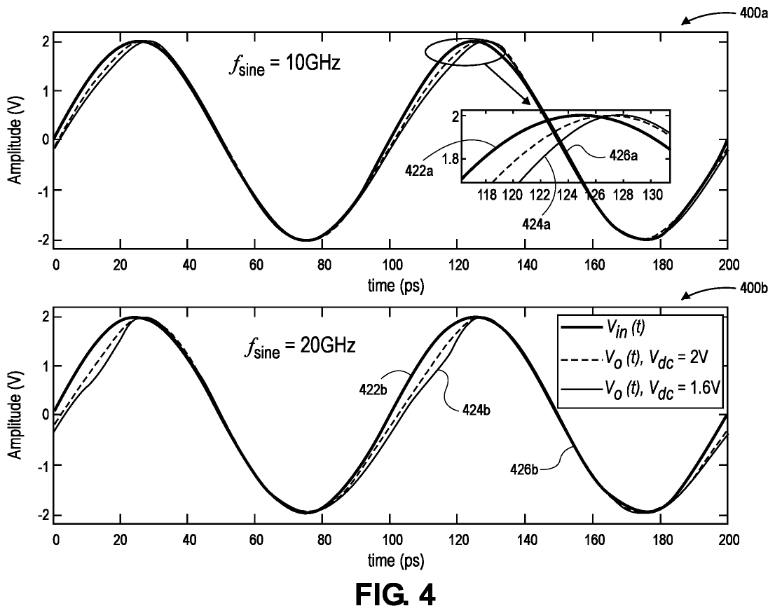

FIG. 4 illustrates an example response of a p-n junction diode to a sinusoidal input signal, in accordance with some embodiments. Diagrams 400a and 400b illustrate responses of the p-n junction diode to a sinusoidal input (A=2, Vₚₚ=4V) with 10 GHz and 20 GHz frequency, respectively, using Eq. (2).

The diode parameters are set based on the fitting in diagram 200a of FIG. 2. The output signal, Vₒ(t), is normalized to have similar amplitude as the input. The rising edge of the output signal 422a, 424a, 422b, 424b is slower compared to the falling edge 426a, 426b resulting in a voltage amplitude-dependent skew. The skew can be controlled through V_{dc}, which in turn changes the reverse-bias operation point of the p-n junction diode. As V_{dc} decreases, larger skew can be achieved at the output; however, there is additional distortion due to operation close to diode forward bias region. Comparison of diagrams 400a and 400b shows that the skew and the distortion are dependent on the signal frequency. Nonetheless, 4 picoseconds (ps) of skew (˜20% of unit interval (UI) for 53 Gbaud) between high- and low-level of PAM4 eye, such as is shown with pattern 111 that includes eyes 113 of FIG. 1, can be achieved with minimal distortion.

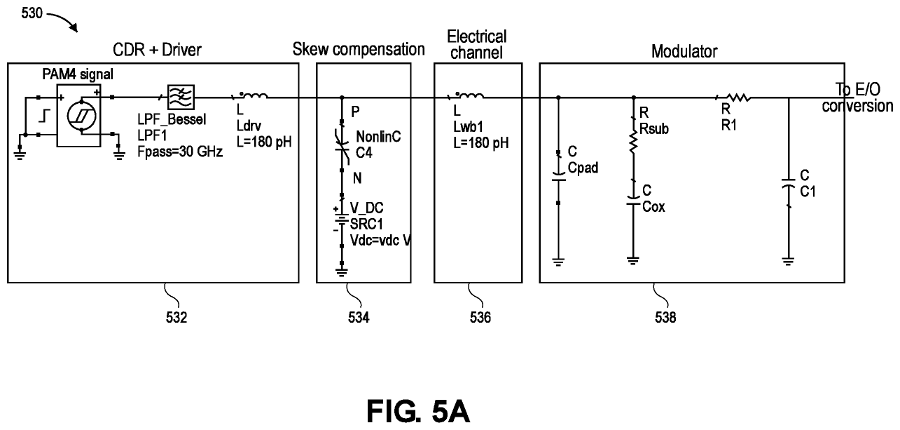

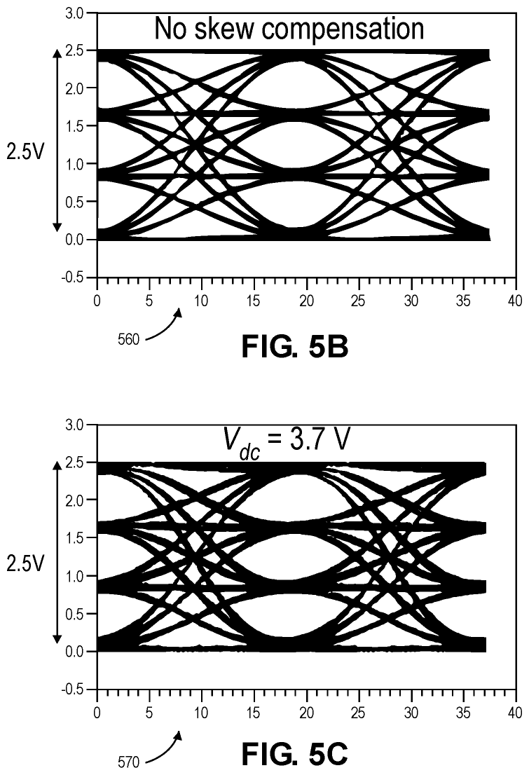

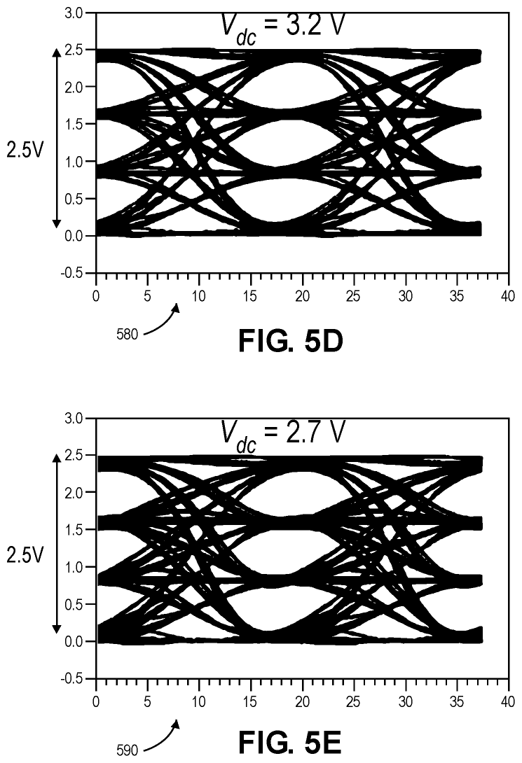

FIGS. 5A-5E illustrate results of simulations for transmitters with skew compensation, in accordance with some embodiments. FIG. 5A shows a PAM4 simulation setup 530 used to generate PAM4 eye diagram 570 of FIG. 5C, 580 of FIG. 5D, and 590 of FIG. 5E in comparison to a PAM4 eye diagram 560 of FIG. 5B to which skew compensation has not been applied.

Turning back to FIG. 5A, simulation setup 530 includes a CDR and driver 532, which may be similar to CDR 102 and driver 106 of FIG. 1. Skew compensation 534 may be similar to skew control device 110 of FIG. 1. Electrical channel 536 may connect skew compensation device 534 to modulator 538. Modulator 538, which also may be referred to as a ring equivalent circuit, ring modulator, or modulator equivalent circuit, may be similar to modulator 114 of FIG. 1.

With respect to simulation setup 530, PAM4 signals at 53.125 Gbaud are generated with a bit pattern generator and fed to a Bessel-Thomson 4^{th} order filter with 30 GHz bandwidth. An inductance of 180 pH is used to optimize the driver output signal after the low pass filter. The skew compensation circuit 534 includes of a nonlinear voltage-dependent capacitance model based on SPICE simulations given in diagram 200a of FIG. 2 and a DC voltage supply to control the p-n junction diode reverse-bias operation point. The electrical channel is modeled as a lumped inductance of 180 pH. The ring equivalent circuit 538 is extracted based on measured S11 data. An additional 10 femtofarad (fF) capacitance is assumed for the pads in the simulations. The electrical signal has a peak-to-peak voltage of 2.5V.

PAM4 eye diagram 560 shows the signal without any skew compensation. The PAM4 eye diagrams 570, 580, 590 show results of the various simulations described in reference to FIG. 5A and show signals with pre-skew compensation for different DC supply voltages. As shown, different eye skews can be achieved by varying V_{dc}. This allows continuous skew adjustment for performance optimization depending on the transmitter operation point and the transmission distance. The eye diagrams show minimal distortion up to 2.7 V DC voltage corresponding to the p-n junction diode operation range of −2.7 V to −0.2 V. The skew between PAM4 high- and low-level is 3.6 ps for V_{dc}=2.7 V, which shows skews up to ˜20% of UI can be compensated.

For the electro-optic co-simulation, the transmitter electrical chain is modeled as described in the previous part. For the E/O conversion, the ring modulator 538 is modeled based on the ring time-dependent dynamics capturing both static and dynamic nonlinearities. A TDECQ metric may be used to quantify the improvement from the skew correction.

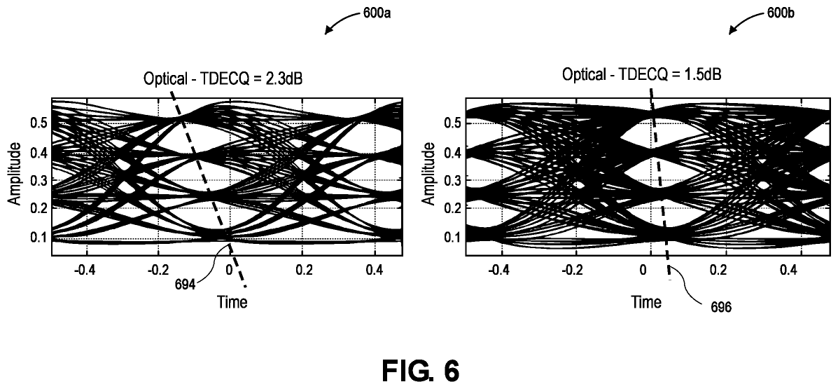

FIG. 6 illustrates a diagram of a transmitter output with and without eye skew compensation, in accordance with some embodiments. Diagram 600a shows an optical eye diagram without skew compensation, and diagram 600b shows an optical eye diagram with skew compensation, at the output of the transmitter, which may be similar to optical signal 116 of FIG. 1.

Without any skew compensation, as shown in diagram 600a, the time delay between PAM4 0-level and 3-level is close to 20% of the UI, which translates into additional TDECQ penalty. This may be seen by the non-vertical centerline 694 of the eyes. With optimized compensated skew as shown in diagram 600b, the three eyes become more symmetric and the time delay decreases to <5% of the UI. This may be seen by the near vertical centerline 696 of the eyes. The TDECQ improves from 2.3 dB to 1.5 dB with the skew correction. Thus, the simulation shows the effectiveness of pre-skewing the electric signal prior to E/O conversion, and that the resulting distortion is within allowed limits of the receiver.

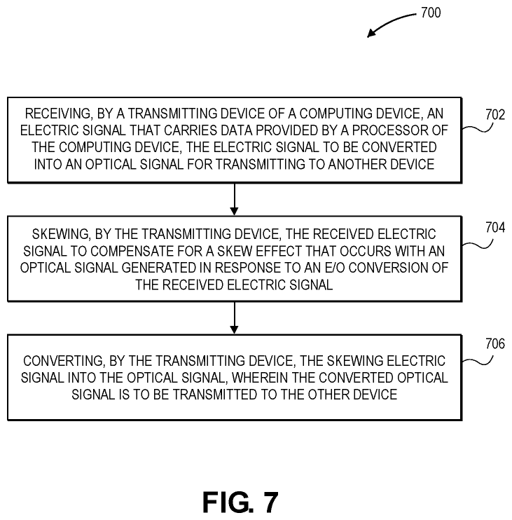

FIG. 7 is a block diagram that illustrates a method for implementing optical signal skew compensation in an optical transmitting device, in accordance with some embodiments. Process 700 may be implemented by one or more techniques described with respect to FIGS. 1-6, and in particular with respect to diagram 100 of FIG. 1 and simulation setup 530 of FIG. 5A.

At block 702, the process may include receiving, by a transmitting device of a computing device, an electric signal that carries data provided by a processor of the computing device, the electric signal to be converted into an optical signal for transmitting to another device. The computing device may also be a switch. As described in reference to FIG. 1, the electric signal is to be converted into an optical signal for transmitting to another device. In embodiments, the transmitting device or a processor of the computing device may include the CDR 102 and/or driver 106 of FIG. 1, or the CDR and driver 532 of FIG. 5A. The electrical signal may be similar to the PAM-based electrical signal 104 or amplified signal 108 of FIG. 1.

At block 704, the process may include skewing, by the transmitting device, the received electric signal to compensate for a skew effect that occurs with an optical signal generated in response to an E/O conversion of the received electric signal. In embodiments, skewing may be accomplished by the skew control device 110 of FIG. 1, reverse junction p-n junction diode of diagram 300 of FIG. 3, or skew compensation 534 of FIG. 5A. As described above, in embodiments the compensation for the skew effect may be implemented by varying a DC voltage, such as V_{dc} of FIG. 1.

At block 706, the process may include converting, by the transmitting device, the skewed electric signal into the optical signal, wherein the converted optical signal is to be transmitted to the other device. In embodiments, the converting may be performed by the modulator 114 of FIG. 1, or modulator 538 of FIG. 5A. In embodiments, the converted optical signal may exhibit vertical or substantially vertical PAM eye alignment as shown by pattern 117 of FIG. 1, diagram 570 of FIG. 5C, or diagram 600b of FIG. 6.

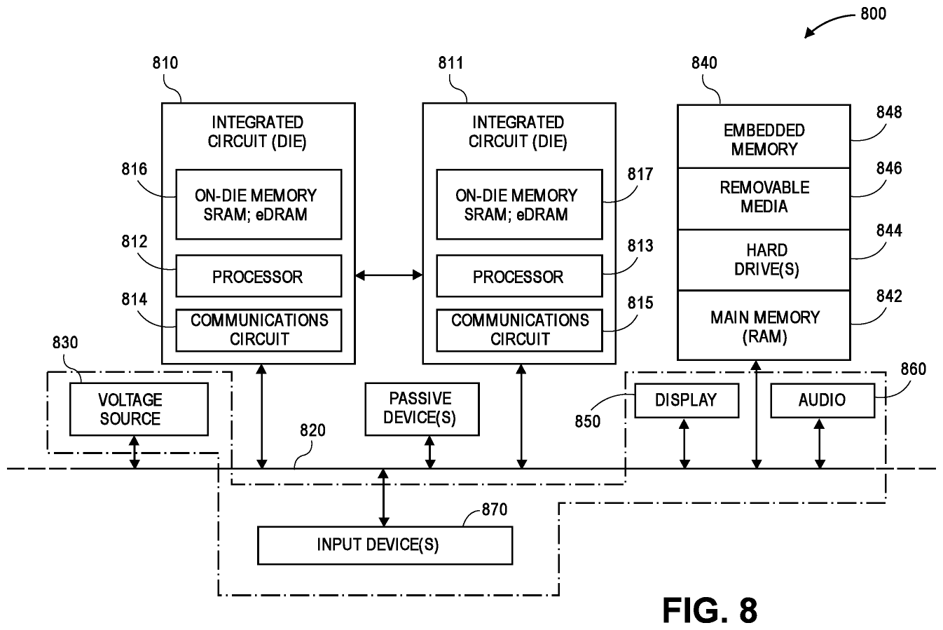

FIG. 8 is a schematic diagram of a computer system 800 with eye skew compensation, in accordance with some embodiments. The computer system 800 (also referred to as the electronic system 800) as depicted can embody optical signal skew compensation according to any of the several disclosed embodiments and their equivalents as set forth in this disclosure. The computer system 800 may be a mobile device such as a netbook computer or wireless smart phone. The computer system 800 may be a desktop computer. The computer system 800 may be a hand-held reader. The computer system 800 may be a server system. The computer system 800 may be a supercomputer or high-performance computing system.

In an embodiment, the electronic system 800 is a computer system that includes a system bus 820 to electrically couple the various components of the electronic system 800. The system bus 820 is a single bus or any combination of busses according to various embodiments. The electronic system 800 includes a voltage source 830 that provides power to the integrated circuit 810. In some embodiments, the voltage source 830 supplies current to the integrated circuit 810 through the system bus 820.

The integrated circuit 810 is electrically coupled to the system bus 820 and includes any circuit, or combination of circuits according to an embodiment. In an embodiment, the integrated circuit 810 includes a processor 812 that can be of any type. As used herein, the processor 812 may mean any type of circuit such as, but not limited to, a microprocessor, a microcontroller, a graphics processor, a digital signal processor, or another processor. In an embodiment, the processor 812 includes, or is coupled with, optical signal skew compensation, as disclosed herein. In an embodiment, SRAM embodiments are found in memory caches of the processor. Other types of circuits that can be included in the integrated circuit 810 are a custom circuit or an application-specific integrated circuit (ASIC), such as a communications circuit 814 for use in wireless devices such as cellular telephones, smart phones, pagers, portable computers, two-way radios, and similar electronic systems, or a communications circuit for servers. In an embodiment, the integrated circuit 810 includes on-die memory 816 such as static random-access memory (SRAM). In an embodiment, the integrated circuit 810 includes embedded on-die memory 816 such as embedded dynamic random-access memory (eDRAM).

In an embodiment, the integrated circuit 810 is complemented with a subsequent integrated circuit 811. Useful embodiments include a dual processor 813 and a dual communications circuit 815 and dual on-die memory 817 such as SRAM. In an embodiment, the dual integrated circuit 811 includes embedded on-die memory 817 such as eDRAM.

In an embodiment, the electronic system 800 also includes an external memory 840 that in turn may include one or more memory elements suitable to the particular application, such as a main memory 842 in the form of RAM, one or more hard drives 844, and/or one or more drives that handle removable media 846, such as diskettes, compact disks (CDs), digital variable disks (DVDs), flash memory drives, and other removable media known in the art. The external memory 840 may also be embedded memory 848 such as the first die in a die stack, according to an embodiment.

In an embodiment, the electronic system 800 also includes a display device 850, an audio output 860. In an embodiment, the electronic system 800 includes an input device such as a controller 870 that may be a keyboard, mouse, trackball, game controller, microphone, voice-recognition device, or any other input device that inputs information into the electronic system 800. In an embodiment, an input device 870 is a camera. In an embodiment, an input device 870 is a digital sound recorder. In an embodiment, an input device 870 is a camera and a digital sound recorder.

As shown herein, the integrated circuit 810 can be implemented in a number of different embodiments, including a package substrate having optical signal skew compensation, according to any of the several disclosed embodiments and their equivalents, an electronic system, a computer system, one or more methods of fabricating an integrated circuit, and one or more methods of fabricating an electronic assembly that includes a package substrate having optical signal skew compensation, according to any of the several disclosed embodiments as set forth herein in the various embodiments and their art-recognized equivalents. Optical signal skew compensation may also be implemented in a transmitter, which may be a part of a communication circuit 815. The elements, materials, geometries, dimensions, and sequence of operations can all be varied to suit particular I/O coupling requirements including array contact count, array contact configuration for a microelectronic die embedded in a processor mounting substrate according to any of the several disclosed package substrates having optical signal skew compensation embodiments and their equivalents. A foundation substrate may be included, as represented by the dashed line of FIG. 8. Passive devices may also be included, as is also depicted in FIG. 8.

The corresponding structures, material, acts, and equivalents of all means or steps plus function elements in the claims below are intended to include any structure, material, or act for performing the function in combination with other claimed elements that are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

### EXAMPLES

Examples, according to various embodiments, may include the following.

Example 1 is an apparatus, comprising: a data provision device; a driver coupled with the data provision device to drive an electric signal resulting from a data provision source; and a skew control device coupled with the driver to skew the electric signal that is to be provided for an electrical to optical (E/O) conversion, to compensate for a skew effect that occurs in an optical signal generated in response to the E/O conversion of the electric signal.

Example 2 may include the apparatus of example 1, wherein the skew control device includes a reverse-biased p-n junction diode to compensate for the skew effect.

Example 3 may include the apparatus of any one of examples 1-2, wherein the driver is integrated in an integrated circuit (IC), and wherein the reverse-biased p-n junction diode is included in the driver.

Example 4 may include the apparatus of any one of examples 1-2, wherein the reverse-biased p-n junction diode is included in a photonics circuit.

Example 5 may include the apparatus of any one of examples 1-2, wherein the reverse-biased p-n junction diode is to cause a voltage-based amplitude-dependent delay in the electric signal.

Example 6 may include the apparatus of example 5, wherein the skew provided by the skew control device ranges from 0.5 volts DC to 5 volts DC.

Example 7 may include the apparatus of example 1, wherein the data provision device is a clock and data recovery (CDR).

Example 8 may include the apparatus of any one of examples 1-2, wherein the apparatus comprises a multi-level pulse amplitude modulation optical transmitter.

Example 9 may include the apparatus of any one of examples 1-2, further comprising a micro-ring modulator (MRM) or a directly modulated laser (DML) coupled with the skew control device, to provide the E/O conversion of the electric signal.

Example 10 may include the apparatus of any one of examples 1-2, wherein the electric signal comprises an eye pattern, wherein the skew effect comprises a distortion of the eye pattern.

Example 11 is a method comprising: receiving, by a transmitting device of a computing device, an electric signal that carries data provided by a processor of the computing device, the electric signal to be converted into an optical signal for transmitting to another device; skewing, by the transmitting device, the received electric signal to compensate for a skew effect that occurs with an optical signal generated in response to an E/O conversion of the received electric signal; and converting, by the transmitting device, the skewed electric signal into the optical signal, wherein the converted optical signal is to be transmitted to the other device.

Example 12 may include the method of example 11, wherein skewing the received electric signal further includes causing a voltage-based amplitude-dependent delay in the received electric signal.

Example 13 may include the method of example 11, wherein skewing the received electric signal further includes applying a DC voltage to a reverse-biased p-n junction diode.

Example 14 may include the method of example 13, further including optimizing the p-n junction diode by varying a capacitance or a resistance of the reverse-biased p-n junction diode.

Example 15 may include the method of example 11, wherein the electric signal comprises an eye pattern, wherein the skew effect comprises a distortion of the eye pattern.

Example 16 is a computing device, comprising: a processor, to generate data that is to be transmitted to another device; and a transmitting device coupled with the processor, wherein the transmitting device includes: a driver, to drive an electric signal that carries the data provided by the processor; a skew control device coupled with the driver to skew the electric signal, to compensate for a skew effect that occurs in an optical signal generated in response to an electrical to optical (E/O) conversion of the electric signal; and an E/O converting device coupled with the skew control device, to generate the optical signal, wherein the skew effect in the generated optical signal is minimized by the skew of the electric signal, wherein the optical signal is to be transmitted to the other device.

Example 17 may include the computing device of example 16, wherein the transmitting device includes a clock and data recovery (CDR) coupled with the driver, to provide the electric signal that carries the data.

Example 18 may include the computing device of any one of examples 16-17, further comprising a photonic IC to transmit the generated optical signal.

Example 19 may include the computing device of any one of examples 16-17, wherein the skew control device comprises an IC.

Example 20 may include the computing device of any one of examples 16-17, further comprising a micro-ring modulator (MRM) or a directly modulated laser (DML) coupled with the skew control device, to provide the E/O conversion of the electric signal.

What is claimed is:

1. An apparatus, comprising:
a data provision device;
a driver coupled with the data provision device to drive an electric signal resulting from a data provision source; and
a skew control device coupled with the driver to skew the electric signal that is to be provided for an electrical to optical (E/O) conversion, to compensate for a skew effect that occurs in an optical signal generated in response to the E/O conversion of the electric signal.

2. The apparatus of claim 1, wherein the skew control device includes a reverse-biased p-n junction diode to compensate for the skew effect.

3. The apparatus of claim 2, wherein the driver is integrated in an integrated circuit (IC), and wherein the reverse-biased p-n junction diode is included in the driver.

4. The apparatus of claim 2, wherein the reverse-biased p-n junction diode is included in a photonics circuit.

5. The apparatus of claim 2, wherein the reverse-biased p-n junction diode is to cause a voltage-based amplitude-dependent delay in the electric signal.

6. The apparatus of claim 5, wherein the skew provided by the skew control device ranges from 0.5 volts DC to 5 volts DC.

7. The apparatus of claim 1, wherein the data provision device is a clock and data recovery (CDR).

8. The apparatus of claim 1, wherein the apparatus comprises a multi-level pulse amplitude modulation optical transmitter.

9. The apparatus of claim 1, further comprising a micro-ring modulator (MRM) or a directly modulated laser (DML) coupled with the skew control device, to provide the E/O conversion of the electric signal.

10. The apparatus of claim 1, wherein the electric signal comprises an eye pattern, wherein the skew effect comprises a distortion of the eye pattern.

11. A method comprising:
receiving, by a transmitting device of a computing device, an electric signal that carries data provided by a processor of the computing device, the electric signal to be converted into an optical signal for transmitting to another device;
skewing, by the transmitting device, the received electric signal to compensate for a skew effect that occurs with an optical signal generated in response to an E/O conversion of the received electric signal; and
converting, by the transmitting device, the skewed electric signal into the optical signal, wherein the converted optical signal is to be transmitted to the other device.

12. The method of claim 11, wherein skewing the received electric signal further includes causing a voltage-based amplitude-dependent delay in the received electric signal.

13. The method of claim 11, wherein skewing the received electric signal further includes applying a DC voltage to a reverse-biased p-n junction diode.

14. The method of claim 13, further including optimizing the p-n junction diode by varying a capacitance or a resistance of the reverse-biased p-n junction diode.

15. The method of claim 11, wherein the electric signal comprises an eye pattern, wherein the skew effect comprises a distortion of the eye pattern.

16. A computing device, comprising:
a processor, to generate data that is to be transmitted to another device; and
a transmitting device coupled with the processor, wherein the transmitting device includes:
a driver, to drive an electric signal that carries the data provided by the processor;
a skew control device coupled with the driver to skew the electric signal, to compensate for a skew effect that occurs in an optical signal generated in response to an electrical to optical (E/O) conversion of the electric signal; and
an E/O converting device coupled with the skew control device, to generate the optical signal, wherein the skew effect in the generated optical signal is minimized by the skew of the electric signal, wherein the optical signal is to be transmitted to the other device.

17. The computing device of claim 16, wherein the transmitting device includes a clock and data recovery (CDR) coupled with the driver, to provide the electric signal that carries the data.

18. The computing device of claim 16, further comprising a photonic IC to transmit the generated optical signal.

19. The computing device of claim 16, wherein the skew control device comprises an IC.

20. The computing device of claim 16, further comprising a micro-ring modulator (MRM) or a directly modulated laser (DML) coupled with the skew control device, to provide the E/O conversion of the electric signal.
